(19) United States
(12) Patent Application Publication
(10) Pub. No.: US 2020/0167399 A1
(43) Pub. Date: May 28, 2020

(54) Bulk Processing of Textual Search Engine Queries

(71) Applicant: Rise Interactive Media & Analytics, LLC, Chicago, IL (US)

(72) Inventors: Brent Laufenberg, Chicago, IL (US); Natalia Horst, Chicago, IL (US); Eric Sherlock, Chicago, IL (US)

(21) Appl. No.: 16/679,587

(22) Filed: Nov. 11, 2019

Related U.S. Application Data
(63) Continuation of application No. 15/611,226, filed on Jun. 1, 2017, now abandoned.

(51) Int. Cl. G06F 16/9532; G06F 16/9538

(52) U.S. Cl. CPC G06F 16/9532; G06F 16/9538

(57) ABSTRACT

An embodiment may involve receiving textual search queries that were entered into a web site. The embodiment may further involve generating a set of conforming textual search queries by removing, from the textual search queries, those that contain non-alphanumeric characters, more than a threshold number of characters, or are duplicates of another of the textual search queries. The embodiment may further involve applying pre-defined transformation rules to the conforming textual search queries to create records respectively associated with the conforming textual search queries, wherein each of the records contains a particular conforming textual search query, a reference to a web page on the web site containing content related to the particular conforming textual search query, and text describing a category of the particular conforming textual search query. The embodiments may further involve transmitting, to an Internet search engine, one or more files containing the records.

### BACKGROUND

This application is a continuation of and claims priority to U.S. patent application Ser. No. 15/611,226, filed Jun. 1, 2017, which is hereby incorporated by reference in its entirety.

### BACKGROUND

Online advertising involves the development and distribution of advertising copy (ads) for online display. Paid search advertising is a particular method of online advertising in which ads are served on web pages that show results from search engine queries. An advertiser may participate in paid search advertising by bidding on one or more key search terms (called keywords) through an auction that is held by an online advertising service. For instance, the advertiser may establish a paid search advertising campaign for the advertiser's web site by placing bids on one or more keywords with which the advertiser would like the advertiser's web site to be associated. Once the advertising campaign is established, if the bids placed by the advertiser are high enough, one or more URLs addressing web pages on the advertiser's web site may be listed in the search results for the keywords.

By way of example, a baseball bat retailer may operate a website having a uniform resource locator (URL) of www.buybaseballbats.example. To engage in paid search advertising, the retailer may establish an advertising campaign with an online advertising service and bid on the keywords “baseball bat”. If the bids are high enough, when a user searches for “baseball bats” on a search engine operated by or on behalf of the online advertising service, the search results may include an ad related to products featured at www.buybaseballbats.example. For instance, the ad may contain an embedded link to www.buybaseballbats.example. If the user clicks on or otherwise activates this link, the user may be directed to the retailer's web site.

In some cases, an advertiser may engage in widespread paid search advertising, bidding on thousands or millions of keywords. Further, the advertiser may update its paid search advertising on a periodic basis (e.g., daily, weekly, etc.). For instance, the advertiser may add new keywords, remove existing keywords, or pause the paid search advertising for particular keywords.

### SUMMARY

The embodiments herein involve, but are not limited to, systems and methods for turning search terms into online advertising information and keywords, and transmitting the online advertising information and keywords to online advertising services to carry out paid search advertising. In particular, the computer implementations described hereafter may obtain a bulk representation of textual search engine queries, process and transform the textual search engine queries into online advertising information, and bulk upload the online advertising information to a server device to facilitate paid search advertising.

In some cases, the bulk representation of textual search engine queries may include textual search engine queries that have been entered by users on an advertiser's web site. For instance, the textual search engine queries may be compiled based on textual search engine queries that have been entered by users on an online shopping web site. The computer implementations described herein may allow the advertiser to convert the textual search engine queries into keywords and associated online advertising information (e.g., advertising campaigns and advertising groups), and to carry out paid search advertising using the textual search engine queries as keywords. The conversion of textual search engine queries into keywords may involve de-duplicating the textual search engine queries, detecting non-conforming textual search engine queries, cleansing textual search engine queries, and generating the associated online advertising information.

Accordingly, a first example embodiment may involve receiving, from a third-party computing device, a bulk representation of textual search engine queries, and in response to receiving the files containing the bulk representation of textual search engine queries, processing each textual search engine query in the bulk representation of textual search engine queries. The processing may include detecting non-conforming textual search engine queries and generating respective online advertising information for the conforming textual search engine queries. The first example embodiment may further involve transmitting, to a server device, at least one file representing the respective online advertising information for the conforming textual search engine queries. Reception of the at least one file and a subsequent command by the server device may cause a search engine device to carry out paid search advertising with the conforming textual search engine queries as keywords and in accordance with the respective online advertising information for the conforming textual search engine queries.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as memory and program instructions. The program instructions may be stored in the memory, and upon execution by the at least one processor, cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 depicts an architecture for paid search advertising, in accordance with example embodiments.

FIG. 2 is a high-level depiction of a client-server computing system, in accordance with example embodiments.

FIG. 3 illustrates a schematic drawing of a computing device, in accordance with example embodiments.

FIG. 4 illustrates a schematic drawing of a networked server cluster, in accordance with example embodiments.

FIG. 5 depicts an information flow for bulk processing of textual search engine queries, in accordance with example embodiments.

FIG. 6 depicts online advertising information templates, in accordance with example embodiments.

FIG. 7 depicts a mapping table and advertising copy templates, in accordance with example embodiments.

FIG. 8 depicts an information flow for bulk processing of an updated representation of textual search engine queries, in accordance with example embodiments.

FIG. 9 depicts a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

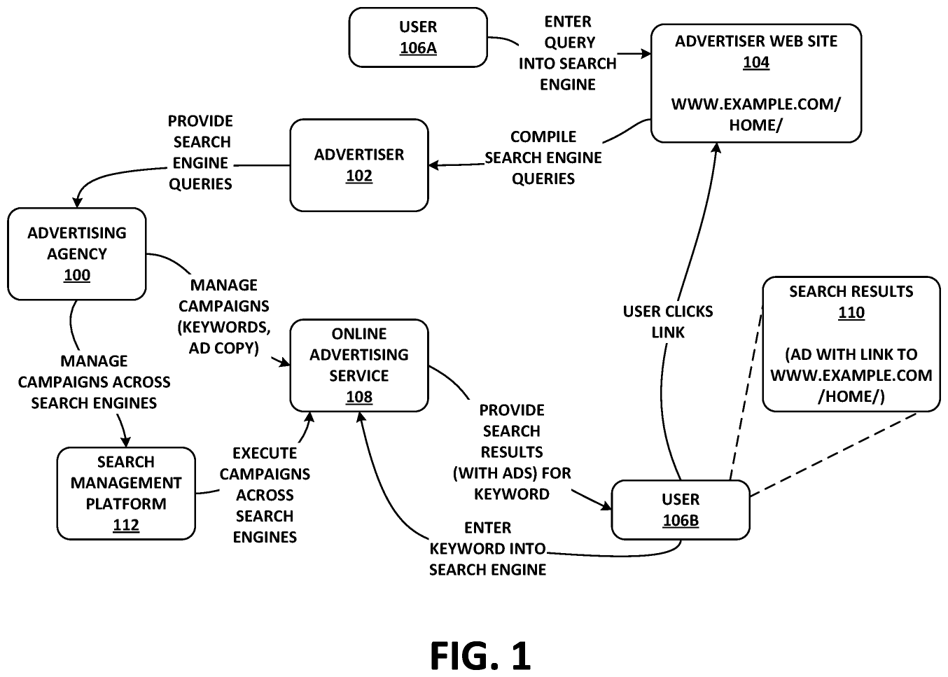

As noted above, the computer implementations described herein may involve conversion of a bulk representation of textual search engine queries into online advertising information, and execution of paid search advertising using the converted textual search engine queries as keywords. FIG. 1 depicts an architecture for paid search advertising. In particular, FIG. 1 involves advertising agency 100, advertiser 102, advertiser web site 104, user 106a, user 106b, online advertising service 108, search results 110, and search management platform 112. In some embodiments, however, more or fewer entities or objects may be involved, and the operations performed by the entities or objects may be different.

Thus, the arrangement depicted in FIG. 1 is for purpose of example. While only one advertiser, advertiser web site, and online advertising service are shown, two or more of each of these entities may exist. Further, the arrangement of FIG. 1 can be scaled up to serve millions of users.

Advertising agency 100 may be hired by advertiser 102 to assist in the development, placement, and tracking of online advertising for advertiser web site 104. Advertiser 102 may be the owner or operator of advertiser web site 104. Advertiser 102 and advertising agency 100 may, for example, work together to develop advertising copy, select the keywords to bid on at online advertising service 102, and evaluate the resulting online advertising campaigns. On the other hand, either of these parties may operate independently from the other when carrying out these tasks. For instance, advertiser 102 may develop advertising copy, but delegate keyword selection and online advertising campaign evaluation to advertising agency 100. A keyword may include more than one word. For instance, an example of a keyword is “toy truck.”

Advertising agency 100 may manage various aspects of the advertiser's online advertising. Advertising agency 100 may also assist advertiser 102 with other aspects of marketing strategies, branding strategies, and/or sales promotions. In some embodiments, advertiser 102 may take on some or all activities that are attributed herein to advertising agency 100.

Advertiser 102 may engage in paid search advertising to obtain exposure for advertiser web site 104. For instance, advertiser 102 may offer products for sale via advertiser web site 104, and advertiser 102 may engage in paid search advertising to generate web traffic for advertiser website 104 (for sake of simplicity, the term “product” as used herein refers to any product and/or service).

Advertiser web site 104 may consist of one or more web pages, each of which may be static or dynamically generated. In some cases, a particular web page of advertiser web site 104 may be directed to a particular product. For purpose of simplicity, it is assumed that advertiser web site 104 is only advertising for a single web page with a URL of www.example.com/home/. However, in practice, advertiser web site 104 may advertise for multiple web pages, such as individual pages featuring individual products or groups of products.

Advertiser web site 104 may include a search engine for searching for information on advertiser web site 104. For instance, advertiser web site 104 may include a search engine for searching for products sold by advertiser 102. Advertiser web site 104 may compile a list of textual search engine queries entered on advertiser web site 104, and provide the list of textual search engine queries to advertiser 102.

User 106a may be an individual or other entity. User 106a may access the Internet or similar networks to conduct business, entertainment, e-commerce, and so on. For instance, user 106a may enter a textual search engine query on advertiser web site 104 to find a product on advertiser web site 104. As a particular example, user 106a may search for “baseball bat” or “toy truck.” User 106b may also be an individual or other entity that accesses the Internet or similar networks to conduct business, entertainment, e-commerce, and so on.

Online advertising service 108 may be the operator of a search engine, such as GOOGLE® or MICROSOFT®, and may also operate online advertising networks. Online advertising service 108 may allow entities such as advertising agency 100 to bid on search keywords on the behalf of advertiser 102. In this manner, one or more URLs addressing web pages on advertiser web site 104 may be listed in the search results for these keywords if these bids are high enough. For instance, in FIG. 1, advertising agency 100 may establish a paid search advertising campaign for advertiser web site 104. Accordingly, advertising agency 100 may enter bids for one or more keywords with which advertiser 102 would like advertiser web site 104 to be associated.

Once the campaign is associated with keywords, online advertising service 108 may begin displaying ads including advertiser web site 104 to users. For instance, a search engine server device operated by or on behalf of online advertising service 108 may receive search keywords from user 106b and provide user 106b with search results related to these keywords. As shown in FIG. 1, online advertising service 108 may provide search results 110 related to a keyword entered by user 106b in the search engine. One of these search results is an ad related to products featured at www.example.com/home/. For instance, the ad may contain an embedded link to www.example.com/home/. When user 106b clicks on or otherwise activates this link, user 108b is directed to the web page with www.example.com/home/ as its URL (i.e., on advertiser web site 104).

Search management platform 112 may provide services for managing paid search advertising across multiple search engines. Instead of or in addition to interfacing with online advertising service 108 to carry out paid search advertising, advertising agency 100 can bid on search keywords on the behalf of advertiser 102 via search management platform 112. Search management platform 112 may have a direct application programming interface (API) connection with several online advertising services. Advantageously, advertising agency 100 can interface with search management platform 112 to bid on search keywords on not only online advertising service 108 but also on other online advertising services, such as another online advertising service (not shown) operated by a different entity than online advertising service 108.

With current systems, it is difficult to carry out paid search advertising at scale (e.g., as the number of keywords escalates). This is especially true when the keywords or advertising information are changing over time (e.g., daily, weekly, etc.), since the keywords and advertising information may have changed by the time a user is able to organize and implement the paid search advertising for the keywords. For example, in some cases, files of bulk search engine queries may be received on a daily basis, and each day's files may be different from the previous day's files. If each day's files include one million (or more) entries, it would take a human more than one day to enter the keywords. In other words, by the time all of the keywords for a particular day have been entered, the keywords may have already changed. Further, existing systems are not suitable for transforming bulk representations of textual search engine queries into keywords and online advertising information, with the online advertising information being in a format that conforms to an online advertising service's requirements.

The embodiments herein overcome these challenges by providing systems and methods for turning search terms into online advertising information, such that the online advertising information can be deployed to advertising services to carry out paid search advertising. As described more fully below, a computing system may obtain a bulk representation of textual search engine queries, process and transform the textual search engine queries into online advertising information, and bulk upload the online advertising information to a server device to facilitate paid search advertising, with at least some of the textual search engine queries being used as keywords. In some cases, the bulk representation of textual search engine queries may include textual search engine queries that have been entered by users on an advertiser's web site. For instance, the textual search engine queries may be compiled based on textual search engine queries that have been entered by users on an online shopping web site.

Regardless of how they may be implemented, the embodiments herein may make use of one or more computing devices. With computing devices, the processing time for processing a bulk representation of textual search engine queries and uploading online advertising information is a matter of seconds or minutes, allowing changes to keywords to occur more frequently. These computing devices may include, for example, client devices under the control of users, and server devices that directly or indirectly interact with the client devices. Such devices are described in the following section.

### II. Example Computing Devices and Cloud-Based Computing Environments

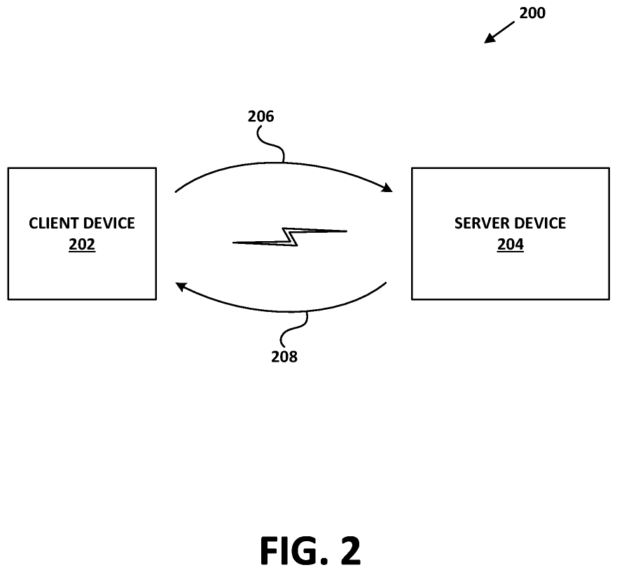

FIG. 2 illustrates an example communication system 200 for carrying out one or more of the embodiments described herein. Communication system 200 may include computing devices. Herein, a “computing device” may refer to either a client device, a server device (e.g., a stand-alone server computer or networked cluster of server equipment), or some other type of computational platform.

Client device 202 may be any type of device including a personal computer, laptop computer, a wearable computing device, a wireless computing device, a head-mountable computing device, a mobile telephone, or tablet computing device, etc., that is configured to transmit data 206 to and/or receive data 208 from a server device 204 in accordance with the embodiments described herein. For example, in FIG. 2, client device 202 may communicate with server device 204 via one or more wireline or wireless interfaces. In some cases, client device 202 and server device 204 may communicate with one another via a local-area network. Alternatively, client device 202 and server device 204 may each reside within a different network, and may communicate via a wide-area network, such as the Internet.

Client device 202 may include a user interface, a communication interface, a main processor, and data storage (e.g., memory). The data storage may contain instructions executable by the main processor for carrying out one or more operations relating to the data sent to, or received from, server device 204. The user interface of client device 202 may include buttons, a touchscreen, a microphone, and/or any other elements for receiving inputs, as well as a speaker, one or more displays, and/or any other elements for communicating outputs.

Server device 204 may be any entity or computing device arranged to carry out the server operations described herein. Further, server device 204 may be configured to send data 208 to and/or receive data 206 from the client device 202.

Data 206 and data 208 may take various forms. For example, data 206 and 208 may represent packets transmitted by client device 202 or server device 204, respectively, as part of one or more communication sessions. Such a communication session may include packets transmitted on a signaling plane (e.g., session setup, management, and teardown messages), and/or packets transmitted on a media plane (e.g., text, graphics, audio, and/or video data).

Regardless of the exact architecture, the operations of client device 202, server device 204, as well as any other operation associated with the architecture of FIG. 2, can be carried out by one or more computing devices. These computing devices may be organized in a standalone fashion, in cloud-based (networked) computing environments, or in other arrangements.

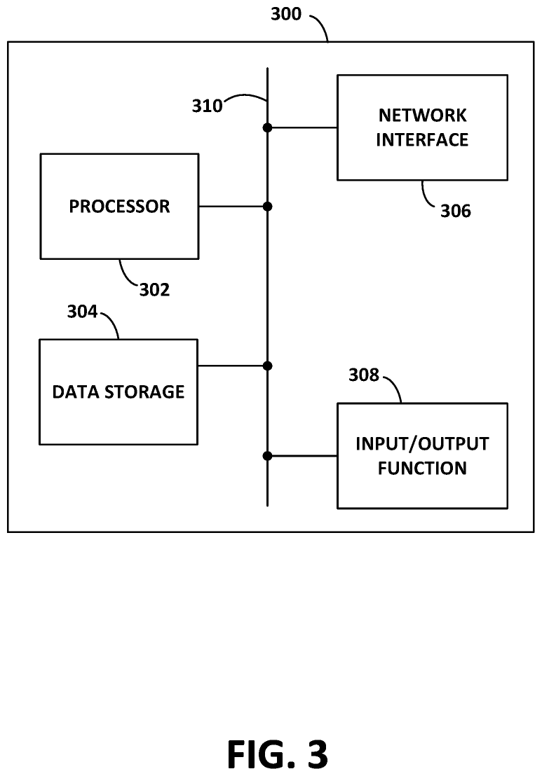

FIG. 3 is a simplified block diagram exemplifying a computing device 300, illustrating some of the components that could be included in a computing device arranged to operate in accordance with the embodiments herein. Example computing device 300 could be a client device, a server device, or some other type of computational platform. For purpose of simplicity, this specification may equate computing device 300 to a server device from time to time. Nonetheless, the description of computing device 300 could apply to any component used for the purposes described herein.

In this example, computing device 300 includes a processor 302, a data storage 304, a network interface 306, and an input/output function 308, all of which may be coupled by a system bus 310 or a similar mechanism. Processor 302 can include one or more central processing units (CPUs), such as one or more general purpose processors and/or one or more dedicated processors (e.g., application specific integrated circuits (ASICs), digital signal processors (DSPs), network processors, etc.).

Data storage 304, in turn, may comprise volatile and/or non-volatile data storage and can be integrated in whole or in part with processor 302. Data storage 304 can hold program instructions, executable by processor 302, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 304 may contain program instructions, perhaps stored on a non-transitory, computer-readable medium, executable by processor 302 to carry out any of the methods, processes, or operations disclosed in this specification or the accompanying drawings.

Network interface 306 may take the form of a wireline connection, such as an Ethernet, Token Ring, or T-carrier connection. Network interface 306 may also take the form of a wireless connection, such as IEEE 802.11 (Wifi), BLUETOOTH®, or a wide-area wireless connection. However, other forms of physical layer connections and other types of standard or proprietary communication protocols may be used over network interface 306. Furthermore, network interface 306 may comprise multiple physical interfaces.

Input/output function 308 may facilitate user interaction with example computing device 300. Input/output function 308 may comprise multiple types of input devices, such as a keyboard, a mouse, a touch screen, and so on. Similarly, input/output function 308 may comprise multiple types of output devices, such as a screen, monitor, printer, or one or more light emitting diodes (LEDs). Additionally or alternatively, example computing device 300 may support remote access from another device, via network interface 306 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

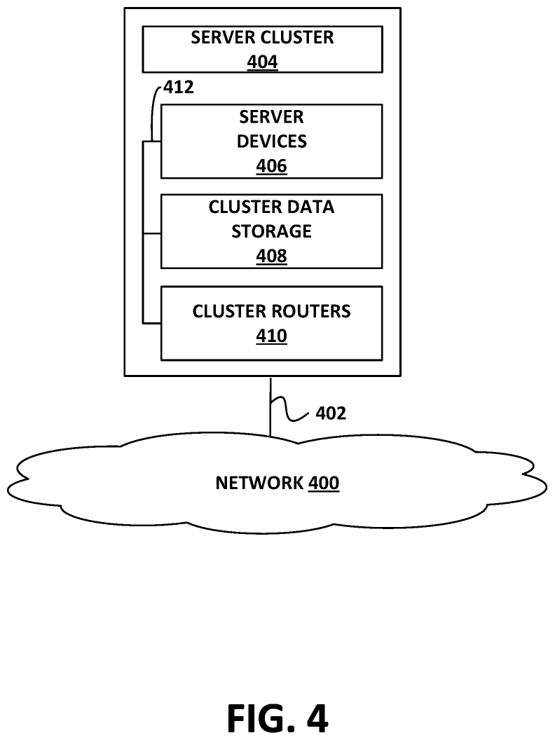

FIG. 4 depicts a cloud-based server cluster 404 in accordance with an example embodiment. In FIG. 4, functions of a server device, such as server device 204 (as exemplified by computing device 300) may be distributed between server devices 406, cluster data storage 408, and cluster routers 410, all of which may be connected by local cluster network 412. The number of server devices, cluster data storages, and cluster routers in server cluster 404 may depend on the computing task(s) and/or applications assigned to server cluster 404.

For example, server devices 406 can be configured to perform various computing tasks of computing device 300. Thus, computing tasks can be distributed among one or more of server devices 406. To the extent that these computing tasks can be performed in parallel, such a distribution of tasks may reduce the total time to complete these tasks and return a result. For purpose of simplicity, both server cluster 404 and individual server devices 406 may be referred to as “a server device.” This nomenclature should be understood to imply that one or more distinct server devices, data storage devices, and cluster routers may be involved in server device operations.

Cluster data storage 408 may be data storage arrays that include disk array controllers configured to manage read and write access to groups of hard disk drives and/or solid state drives. The disk array controllers, alone or in conjunction with server devices 406, may also be configured to manage backup or redundant copies of the data stored in cluster data storage 408 to protect against disk drive failures or other types of failures that prevent one or more of server devices 406 from accessing units of cluster data storage 408.

Cluster routers 410 may include networking equipment configured to provide internal and external communications for the server clusters. For example, cluster routers 410 may include one or more packet-switching and/or routing devices configured to provide (i) network communications between server devices 406 and cluster data storage 408 via cluster network 412, and/or (ii) network communications between the server cluster 404 and other devices via communication link 402 to network 400.

Additionally, the configuration of cluster routers 410 can be based at least in part on the data communication requirements of server devices 406 and cluster data storage 408, the latency and throughput of the local cluster networks 412, the latency, throughput, and cost of communication link 402, and/or other factors that may contribute to the cost, speed, fault-tolerance, resiliency, efficiency and/or other design goals of the system architecture.

As a possible example, cluster data storage 408 may include any form of database, such as a structured query language (SQL) database. Various types of data structures may store the information in such a database, including but not limited to tables, arrays, lists, trees, and tuples. Furthermore, any databases in cluster data storage 408 may be monolithic or distributed across multiple physical devices.

Server devices 406 may be configured to transmit data to and receive data from cluster data storage 408. This transmission and retrieval may take the form of SQL queries or other types of database queries, and the output of such queries, respectively. Additional text, images, video, and/or audio may be included as well. Furthermore, server devices 406 may organize the received data into web page representations. Such a representation may take the form of a markup language, such as the hypertext markup language (HTML), the extensible markup language (XML), or some other standardized or proprietary format. Moreover, server devices 406 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. Example Architecture and Processing

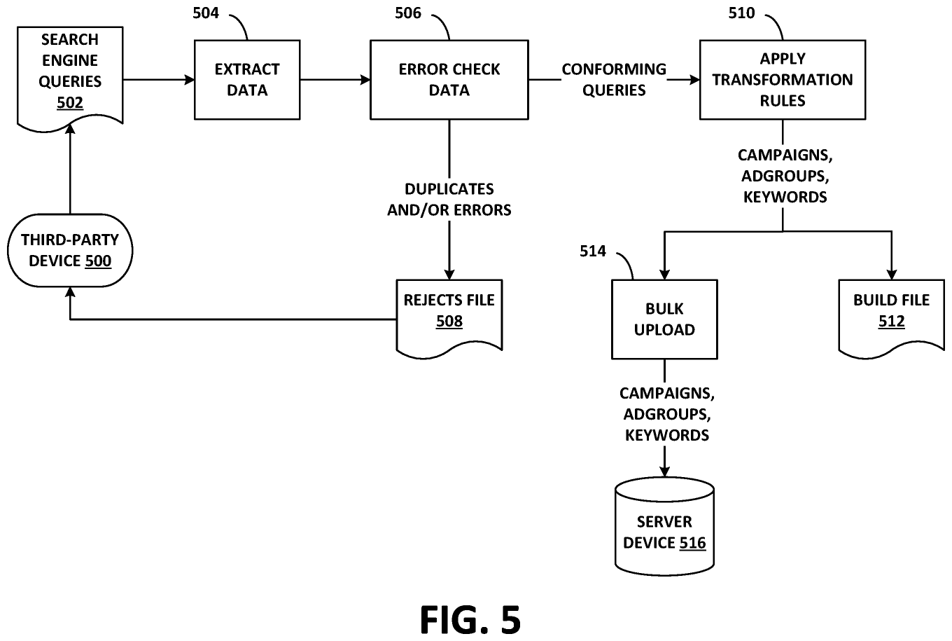

FIG. 5 illustrates an information flow for bulk processing of textual search engine queries, according to an example embodiment. The flow of information starts with third-party device 500 providing information for carrying out the bulk processing. In some embodiments, third-party device 500 may be operated by an advertiser. The advertiser may maintain a database of textual search engine queries, and provide a bulk representation of the textual search engine queries to an advertising agency. For instance, third-party device 500 may upload a copy of the textual search engine queries to a server of the advertising agency in accordance with a file transfer protocol. Alternatively, the advertiser may receive textual search engine queries via an API. The advertiser may have a direct API interface with the third-party device 500, and the advertiser can receive a bulk representation of textual search engine queries via the API.

In one example, third-party device 500 may provide one or more text files 502 that, in combination, include a bulk representation of textual search engine queries. In some cases, the one or more text files 502 may include more than one million textual search engine queries. The one or more text files 502 may also include respective input records corresponding to the textual search engine queries. An example input record for a textual search engine query may include a textual search engine query, term type, page name, and one or more hierarchy level names, as well as other information.

A term type for a textual search engine query may indicate whether the textual search engine query includes only brand names, does not include any brand names, or includes a combination of branded and unbranded terms. For instance, the term type for a textual search engine query of “toy truck” may be “unbranded”, whereas the term type for a textual search engine query of “ABC toy truck” may be “combination”.

A page name for a textual search engine query may include a link to a web page (e.g., a URL) associated with the textual search engine query. For instance, a page name for a textual search engine query may include a web address of a web page featuring a product or category of products corresponding to the textual search engine query.

Hierarchy level names for a textual search engine query may indicate one or any combination of a category, sub-category, sub-sub category, etc., of which a product corresponding to the textual search engine query is a member. As an example, the hierarchy level names for a textual search engine query of “toy truck” may be “Toys/Toy Vehicles/Toy Cars and Trucks” or simply “Toy Cars and Trucks.”

At step 504, the advertising agency may extract data from the one or more files 502 provided by third-party device 500. When extracting the data, the advertising agency may normalize the data in the one or more files 502. The normalization may include converting the information from the third-party device's format to the advertising agency's format, and storing the information into a spreadsheet, text file, or database (referred to hereafter as the advertising agency's database for simplicity). The normalization may also include populating one or more database fields in the advertising agency's database based on the data in the one or more files 502. For instance, for one or more textual search engine queries, the advertising agency may define a term, term ID, term length, derived term type, page name, first hierarchy level, second hierarchy level, third hierarchy level . . . , and last hierarchy level.

The term for a textual search engine query may be the actual textual search engine query. Similarly, the page name may be the page name indicated in the input record.

The term ID for a textual search engine query may be a unique ID corresponding to the textual search engine query. In examples, entries in the advertising agency's database may be organized in rows, with each term ID corresponding to a respective row. Assigning a term ID to a textual search engine query allows the textual search engine query to be tracked as error-checking, de-duplicating, and other processing occurs.

The term length for a textual search engine query may be the number of characters in the textual search engine query. The derived term type for a textual search engine query may be derived from the term type in the input record corresponding to textual search engine query. In one example, the advertising agency may store reference data that maps terms types to derived term types, and the advertising agency may reference the stored reference data to map the term type to the derived term type. For instance, the term type “unbranded” may map to “NonBrnd”, and the term type “branded” may map to “Brands”.

The first hierarchy level, second hierarchy level, third hierarchy level, . . . and last hierarchy level for a textual search engine query may be derived from the hierarchy level names in the input record corresponding to the textual search engine query. For instance, if the hierarchy level names are “Toys/Toy Vehicles/Toy Cars and Trucks,” the first hierarchy level may be “Toys”, the second hierarchy level may be “Toy Vehicles,” the third hierarchy level may be “Toy Cars and Trucks”, and the last hierarchy level may also be “Toy Cars and Trucks”.

At step 506, the advertising agency may error-check the extracted data. Error-checking may involve detecting any textual search engine queries containing non-alphanumeric characters. For example, error-checking may involve processing the advertising agency's database to identify the term ID of any entries in the database for which the value of the “term” database field contains non-alphanumeric characters, such as the plus sign, minus sign, dollar sign, percent sign, or ampersand. In one case, non-alphanumeric characters designating length, such as a double quotation mark (designating inches), single quotation mark (designating feet), or forward slash (designating a fraction) may be deemed acceptable and not flagged as errors. Error-checking may also involve processing the advertising agency's database to identify the term ID of any entries in the database for which a value in a database field other than the “term” database field contains non-alphanumeric characters. Certain non-alphanumeric characters in the “page name” database field, such as the forward slash and the period, may be deemed acceptable and not flagged as errors.

Error-checking may further involve detecting any textual search engine queries containing more than a threshold number of characters. For instance, error-checking may involve processing the advertising agency's database to identify the term ID of any entries in the database for which the value of the “term” database field contains more than 80 characters. Error-checking may also involve detecting any textual search engine queries containing more than a threshold number of words. For instance, error-checking may involve processing the advertising agency's database to identify the term ID of any entries in the database for which the value of the “term” database field contains more than ten words.

Optionally, at step 506, the advertising agency may also de-duplicate the extracted data. De-duplicating the data may involve flagging any textual search engine queries that are duplicate copies of one or more other entries in the textual search engine queries. In one case, de-duplicating the data may involve processing the advertising agency's database to identify the term ID of any entries in the database for which the value of the “term” database field is the same as the value in the “term” database field of any other entries in the database. In another case, de-duplicating the data may involve processing the advertising agency's database to identify the term ID of any entries in the database for which the values of the “term” and “last hierarchy level” database fields are the same as the values of the “term” and “last hierarchy level” database fields of any other entries in the database. Hence, with this approach, entries in the database with the same “term” but different “last hierarchy level” might not be flagged as duplicates. Other methods of de-duplicating the data may also exist.

After error-checking, the advertising agency may send a rejects file 508 to the advertiser. The rejects file 508 may include a representation of the duplicate textual search engine queries and/or the non-conforming textual search engine queries. The non-conforming textual search engine queries may be the textual search engine queries flagged by the error-checking. Thus, the rejects file 508 may inform an operator of third-party device 500 of the textual search engine queries that are duplicates, could not be properly handled by the advertising agency's computing system, and/or would be unacceptable to one or more online advertising services.

At step 510, the advertising agency may apply transformation rules to the conforming textual search engine queries. Applying transformation rules may involve generating respective online advertising information for the conforming textual search engine queries. The respective online advertising information may be added to the advertising agency's database as respective records, and may include information such as respective campaigns, respective advertising groups, respective keywords, respective advertising copy information, and respective web addresses.

Some online advertising services allow an advertising agency to create multiple campaigns, with each campaign including one or more respective advertising groups. Each advertising group, in turn, contains a set of similar advertising copy that targets a shared set of keywords. Advertising agencies may use advertising groups to bundle related advertising copy together with related keywords. As noted above, a keyword may include more than one word.

In some cases, applying transformation rules may involve transforming the values in one or more database fields of the advertising agency's database into advertising campaign names, advertising group names, and keywords. The transformation may occur using one or more online advertising information templates.

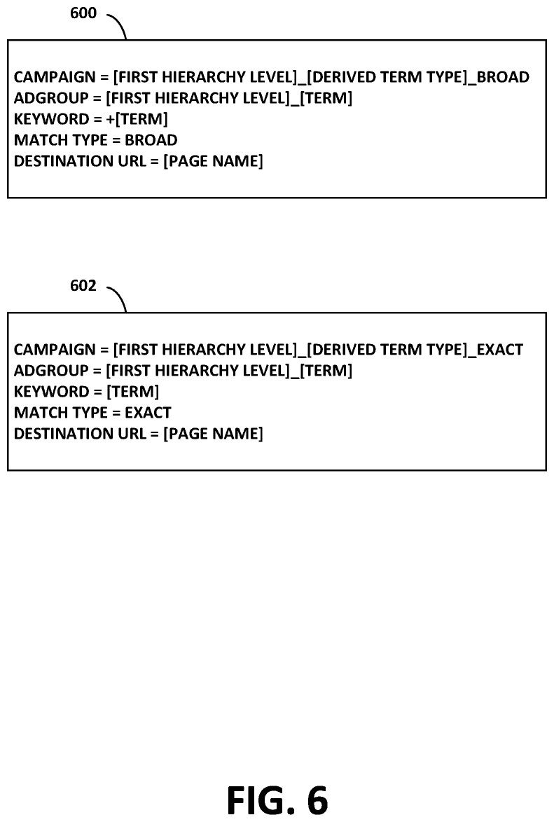

FIG. 6 depicts example online advertising information templates, namely, first template 600 and second template 602. In some cases, the advertising agency may use first template 600 to generate respective advertising campaign names, advertising group names, and keywords. First template 600 is an example of an online advertising information template that the advertising agency may use to specify information for “broad match” search advertising.

With broad match search advertising, an online search engine device may serve advertising copy associated with a keyword for searches that include misspellings and relevant variations of the keyword as well as synonyms of the keyword. In examples, the online search engine device may provide for modified broad match search advertising, where advertising copy associated with a keyword is shown for searches that include misspellings and relevant variations of the keyword, but not for searches that include synonyms of the keyword. Using modified broad match search advertising can help an advertiser reach more relevant customers.

According to first template 600, the campaign name for a conforming textual search engine query may be a text string that is composed, at least in part, of values in the “first hierarchy level” and “derived term type” database fields. For instance, if the first hierarchy level is “Toy Vehicles” and the derived term type is “Unbranded”, the campaign name may be “Toy Vehicles Unbranded Broad”.

Similarly, the advertising group name for a conforming textual search engine query may be a text string that is composed, at least in part, of values in the “first hierarchy level” and “term” database fields. For instance, if the first hierarchy level is “Toy Vehicles” and the term is “toy truck”, the advertising group name may be “Toy Vehicles toy truck”.

First template 600 also shows that, to implement modified broad match search advertising, the advertising agency may transform a conforming textual search engine query into a keyword by adding the plus sign in front of each word in the value in the “term” database field for the conforming textual search engine query. For instance, if the value in the “term” database field is “toy truck”, the keyword may be “+toy +truck”. The presence of the plus sign may signify that the keyword is a modified broad match keyword, rather than a default broad match keyword. In some cases, the advertising agency may also convert each letter in the value in the “term” database field to lowercase.

First template 600 further shows that the destination URL of the record for a conforming textual search engine query may be the value in the “page name” database field.

In some cases, the advertising agency may use second template 602 to generate respective advertising campaign names, advertising group names, and keywords. Second template 602 is an example of an online advertising information template that the advertising agency may use to specify information for “exact match” search advertising. With exact match search advertising, an online search engine device may serve advertising copy associated with a keyword for searches that match the keyword or are close variations of the keyword (e.g., searches that include a reordering of words in the keyword, searches that include the addition or removal of function words such as prepositions, conjunctions, and articles).

According to second template 602, the campaign name for a conforming textual search engine query may be a text string that is composed, at least in part, of values in the “first hierarchy level” and “derived term type” database fields. For instance, if the first hierarchy level is “Toy Vehicles” and the derived term type is “Unbranded”, the campaign name may be “Toy Vehicles_Unbranded_Exact”.

Similarly, the advertising group name for a conforming textual search engine query may be a text string that is composed, at least in part, of values in the “first hierarchy level” and “term” database fields. For instance, if the first hierarchy level is “Toy Vehicles” and the term is “toy truck”, the advertising group name may be “Toy Vehicles_toy truck”.

Second template 602 also shows that, for exact match search advertising, the keyword may be the value in the “term” database field for the conforming textual search engine query. For instance, if the value in the “term” database field is “toy truck”, the keyword may be “toy truck”. In some cases, the advertising agency may also convert each letter in the value in the “term” database field to lowercase.

Second template 600 further shows that the destination URL of the record for a conforming textual search engine query may be the value in the “page name” database field.

The online advertising information templates in FIG. 6 are provided as examples and are not meant to be limiting. In other embodiments, online advertising information templates may utilize other database fields and may utilize more or less database fields than those depicted in FIG. 6.

In some examples, advertising agency may store data mapping values of one or more database field to templates. The advertising agency may refer to the stored data to map a value in the advertising agency's database for a conforming textual search engine query to a template, and use the matched template to generate the online advertising information for the conforming textual search engine query. As an example, advertising agency may store data mapping values in the “derived term type” database field to different templates. For instance, a first template or group of templates may correspond to derived term types of “Brands”, while a second template or group of templates may correspond to derived term types of “NonBrnd”.

In some cases, applying transformation rules may involve transforming the values in one or more database fields of the advertising agency's database into advertising copy. The transformation may occur using one or more online advertising information templates.

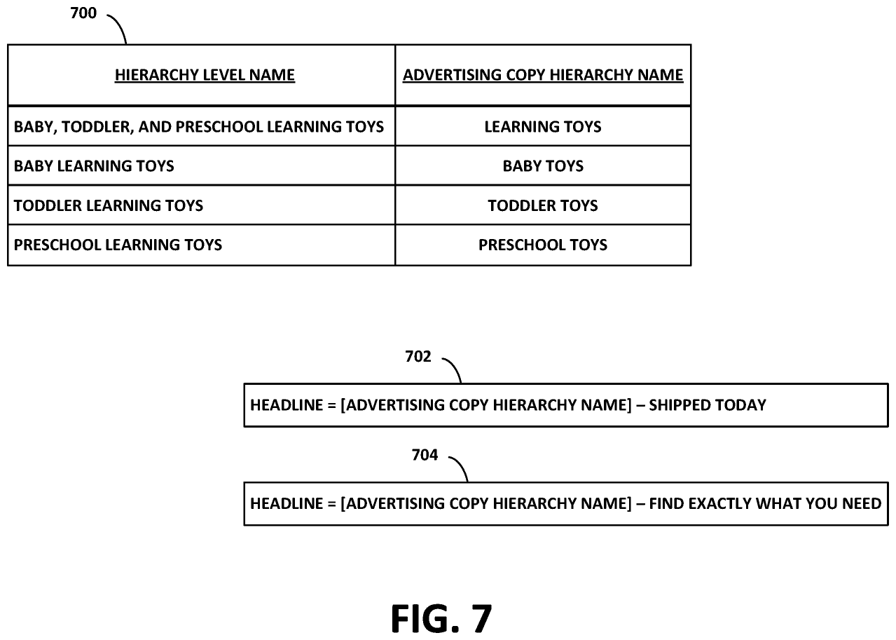

FIG. 7 depicts a mapping table 700, a first template 702, and a second template 704. In some cases, the advertising agency may use mapping table 700 in conjunction with first template 702 or second template 704 to generate advertising copy.

Mapping table 700 shows advertising copy hierarchy names corresponding to hierarchy level names. To generate advertising copy for a conforming textual search engine query, the advertising agency may determine a hierarchy level name corresponding to the conforming textual search engine query from the advertising agency's database and then reference the mapping table 700 to determine an advertising copy hierarchy name corresponding to the hierarchy level name. For instance, the hierarchy level name may be the value in the “last hierarchy level” database field. If the value is “baby learning toys”, then, according to the mapping table 700, the transformed advertising copy hierarchy name may be “baby toys”.

According to the first template 702, the headline for a conforming textual search engine query may be a text string that is composed of the advertising copy hierarchy name and an additional boilerplate text string. Thus, for an advertising copy hierarchy name of “baby toys”, the headline may be “BABY TOYS-SHIPPED TODAY”.

Second template 704 shows another example headline that is composed of the advertising copy hierarchy name and a different boilerplate text string. Thus, for an advertising copy hierarchy name of “toddler toys”, the headline may be “TODDLER TOYS-FIND EXACTLY WHAT YOU NEED”.

In some cases, an online advertising service may limit the length of a headline. The advertising agency may transform the hierarchy level name into the advertising copy hierarchy name so that a length of the generated headline conforms to the limit.

Referring back to FIG. 5, applying transformation rules may also include checking whether the generated online advertising information meets various requirements. For instance, applying the transformation rules may include identifying the term ID of any conforming textual search engine queries for which the campaign name exceeds a campaign name length or the advertising group name exceeds an advertising group name length. If any term IDs are identified, the textual search engine queries for the identified term IDs may be deemed non-conforming, and included in the rejects file 508.

After applying transformation rules, the advertising agency may create a build file 512. The build file 512 may include the online advertising information for the conforming textual search engine queries. For instance, the build file 512 may include records of campaign names, advertising group names, keywords, web addresses, and advertising copy information for the conforming textual search engine queries. Budgeting and bidding information may be present in the build file 512 as well.

At step 514, advertising agency may transmit at least one file to server device 516 as part of a bulk upload. The at least one file may represent information from the build file 512 and may include information to establish paid search advertising with an online advertising service. In particular, the at least one file may represent respective online advertising information for the conforming textual search engine queries. In some cases, the advertising agency may transform information in the build file 512 to a format that corresponds to a format specified by an online advertising service, and include the transformed information in the at least one file. Reception of the at least one file and a subsequent command by the server device may cause a search engine device to carry out paid search advertising with the conforming textual search engine queries as keywords and in accordance with the respective online advertising information.

In one example, the server device 516 may be the search engine device. The advertising agency may have a direct API interface with the search engine device, and the advertising agency can upload the at least one file to the search engine device via the API. Alternatively, a user at the advertising agency can manually upload the at least one file to the search engine device.

In another example, the server device 516 may be a search management platform server. The advertising agency may have a direct API interface with the search management platform server, and the advertising agency can upload the at least one file to the search management platform server via the API. Alternatively, a user at the advertising agency can manually upload the at least one file to the search management platform server.

Reception of the at least one file at the search management platform server may, in turn, cause the search management platform server to transmit a representation of the at least one file to the search engine device, or to transmit representations of the at least one file to multiple search engine devices.

In some cases, reception of the at least one file at the search management platform server may cause the search management platform server to associate one or more hierarchical labels to the respective online advertising information for the conforming textual search engine queries. The hierarchical labels may allow the advertising agency to track the paid search advertising across multiple search engines. In one example, the advertising agency may derive the hierarchical labels from information in the advertising agency's database, and provide the hierarchical labels to the search management platform server (e.g., in the at least one file). For instance, the advertising agency may list the values of one or any combination of “first hierarchy level”, “second hierarchy level”, “third hierarchy level” . . . , and “last hierarchy level” as labels for a conforming textual search engine query.

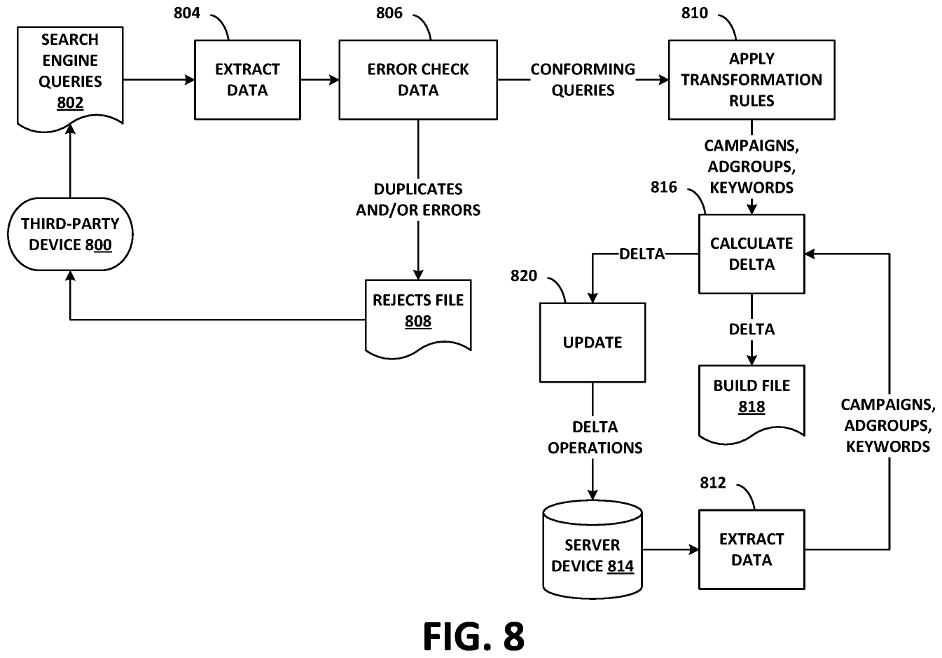

FIG. 8 illustrates an information flow for bulk processing of an updated representation of textual search engine queries, according to an example embodiment. The information flow may occur subsequent to the information flow illustrated in FIG. 5. The flow of information in FIG. 8 starts with third-party device 800 providing information for carrying out the bulk processing. Third-party device 800 may be the third-party device 500 of FIG. 5, for instance. In one example, an operator of third-party device 800 may provide one or more text files 802 that, in combination include a bulk representation of textual search engine queries. In another example, the advertising agency may receive the bulk representation of textual search engine queries via an API.

The textual search engine queries in the one or more files 802 may include some of the textual search engine queries represented in the one or more files 502 of FIG. 5. However, the textual search engine queries in the one or more files 802 may be different from textual search engine queries in the one or more files 502. Specifically, the textual search engine queries in the one or more files 802 may include one or more textual search engine queries that are not in the one or more files 502, or the textual search engine queries in the one or more files 802 might not include all of the textual search engine queries in the one or more files 502.

As in the information flow of FIG. 5, at step 804 the advertising agency may extract data from the one or more files 802 provided by third-party device 800. Further, at step 806, the advertising agency may error-check the extracted data, and optionally, de-duplicate the extracted data. After error-checking, the advertising agency may send a rejects file 808 to the advertiser. And at step 810, the advertising agency may apply transformation rules to the conforming textual search engine queries. Applying transformation rules may involve generating respective online advertising information for the conforming textual search engine queries. The respective online advertising information may be added to the advertising agency's database as respective records, and may include information such as respective campaigns, respective advertising groups, respective keywords, respective advertising copy information, and respective web addresses.

Unlike in the information flow of FIG. 5, at step 812, the advertising agency may extract data from server device 814. Server device 814 may be the server device 516 of FIG. 5. The extracted data may represent one or more paid search advertising campaigns that are currently established for the advertiser. The extracted data may be in the form of respective campaigns, respective advertising groups, respective keywords, respective advertising copy information, and respective web addresses.

After extracting the data, at step 816, advertising agency may calculate differences (i.e. deltas) between the respective records generated at step 810 and the data extracted at step 812. For instance, the advertising agency may identify added textual search engine queries that are represented in the generated records but not represented in the currently established advertising campaigns, or may identify removed textual search engine queries that are represented in the currently established advertising campaigns but not in the generated records. The advertising agency may identify added or removed textual search engine queries by comparing the keywords in the generated records to the extracted keywords.

Additionally or alternatively, for textual search engine queries that are represented in both the generated records and the currently established advertising campaigns, the advertising agency may identify textual search engine queries for which the campaign name, advertising group, advertising copy, or web address has changed.

Calculating the differences may involve updating a build file 818. The build file 818 may be the build file 512 of FIG. 5. For any differences identified by the advertising agency, the advertising agency may modify the build file 818 such that the information in the build file 818 corresponds to the information generated at step 810.

At step 820, advertising agency may then transmit at least one file to server device 814 as part of an update. The at least one file may represent changes to the existing advertising campaign to reflect the differences calculated at step 816. For instance, the at least one file may include instructions for carrying out paid search advertising in accordance with the respective online advertising information for one or more added textual search engine queries. As another example, the at least one file may include instructions for discontinuing paid search advertising in accordance with the respective online advertising information for one or more removed textual search engine queries.

Notably, the embodiments herein require computer implementation. By its very nature, online advertising is premised on the existence of computers and computer networks. Billions of people around the world, accessing the Internet or private networks in various ways, may be viewing ads and visiting web sites. Bulk conversion of search engine queries and related information into online advertisements would not be possible to perform manually, due to the volume of the bulk data. As described in the embodiments above, bulk representations of search engine queries may be received on a daily (or more frequent) basis. Each day's bulk representation may be different from the previous day's files, and may include millions of entries. Since it would take a human more than a day to perform the processing of FIGS. 5 and 8 manually, there is no way to carry out the embodiments herein without computers.

Further, there are no non-computerized analogies for such activities. Keywords do not exist in traditional advertising, and traditional ads are not dynamically selected based on the viewer of the ad or the content of documents in which the ad is embedded. Thus, the solutions presented herein are non-conventional and specifically designed to solve technical problems related to online advertising.

### IV. Example Operations

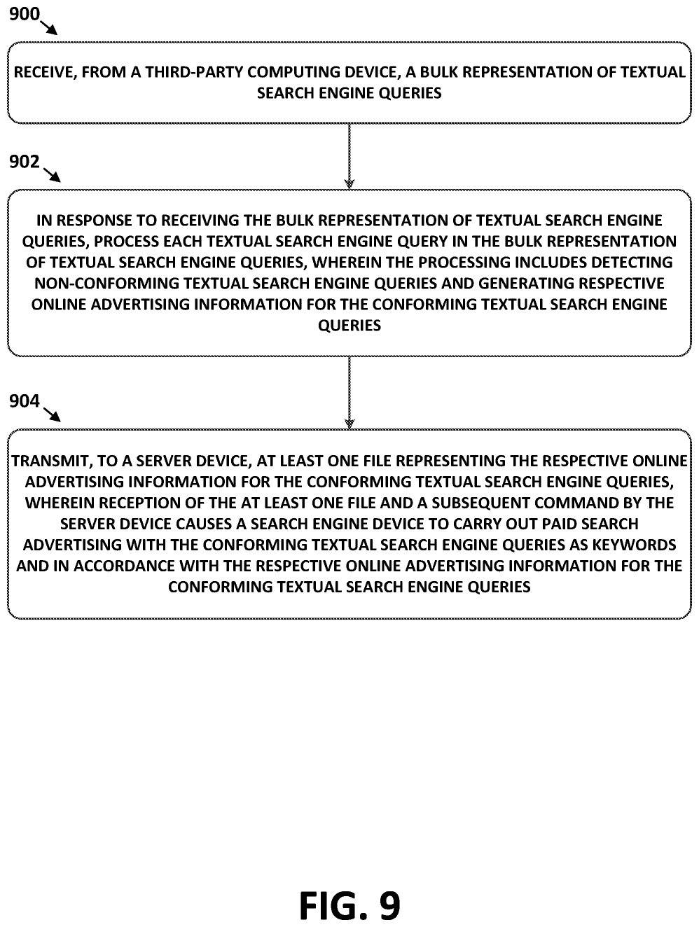

FIG. 9 is a flow chart illustrating an example embodiment. The process illustrated by FIG. 9 may be carried out by a computing device, such as computing device 300, and/or a cluster of computing devices, such as server cluster 404. However, the process can be carried out by other types of devices or device subsystems. For example, the process could be carried out by a portable computer, such as a laptop or a tablet device.

Block 900 may involve receiving, from a third-party computing device, a bulk representation of textual search engine queries.

Block 902 may involve, in response to receiving the bulk representation of textual search engine queries, processing each textual search engine query in the bulk representation of textual search engine queries. The processing may include detecting non-conforming textual search engine queries and generating respective online advertising information for the conforming textual search engine queries.

Detecting the non-conforming textual search engine queries may involve detecting any textual search engine queries containing non-alphanumeric characters or any textual search engine queries having more than a threshold number of characters.

In some embodiments, the processing may further include de-duplicating the textual search engine queries. De-duplicating the textual search engine queries may involve identifying textual search engine queries that are duplicate copies of one or more other entries in the textual search engine queries.

Generating the respective online advertising information for the conforming textual search engine queries may involve generating respective records for the conforming textual search engine queries. The respective records may include indications of respective advertising campaigns, respective advertising groups, and respective web addresses. The respective advertising groups may include respective advertising copy that targets a shared set of the keywords, and the respective advertising campaigns may include one or more of the respective advertising groups. Additionally or alternatively, the respective records may include respective advertising copy information for display in online advertisements.

In some embodiments, the bulk representation of textual search engine queries may also include respective input records corresponding to the textual search engine queries of the bulk representation of textual search engine queries. Generating the respective record for a conforming textual search engine query may involve determining a hierarchy level name based on a value in the respective input records and transforming the hierarchy level name and the conforming textual search engine query into an advertising group using an advertising group template. Further, generating the respective record a conforming textual search engine query may involve: determining an advertising copy hierarchy name based on a value in the respective input records and inserting the advertising copy hierarchy name into an advertising copy template. Determining the advertising copy hierarchy name may involve determining a hierarchy level name based on a value in the respective input records and transforming the hierarchy level name to the advertising copy hierarchy name.

Block 904 may involve transmitting, to a server device, at least one file representing the respective online advertising information for the conforming textual search engine queries. Reception of the at least one file and a subsequent command by the server device may cause a search engine device to carry out paid search advertising with the conforming textual search engine queries as keywords and in accordance with the respective online advertising information for the conforming textual search engine queries.

In some embodiments, the server device may be a search management platform server, and reception of the at least one file and the subsequent command by the server device may cause the server device to: associate one or more hierarchical labels to the respective online advertising information for the conforming textual search engine queries, and transmit, to the search engine device, a representation of the at least one file. Reception of the at least one file and the subsequent command may also cause the server device to transmit, to a second search engine device, a second representation of the at least one file.

In some embodiments, the server device may be the search engine device.

Additional blocks, not explicitly illustrated in FIG. 9, may involve: (i) after the transmitting, receiving, from the third-party computing device, one or more updated files containing, in combination an updated bulk representation of textual search engine queries; (ii) in response to receiving the updated bulk representation of textual search engine queries, processing each textual search engine query, with the processing including detecting added textual search engine queries and generating for the added textual search engine queries respective online advertising information; and (iii) transmitting, to the server device, instructions for carrying out paid search advertising in accordance with the respective online advertising information for the added textual search engine queries. The added textual search engine queries may be detected by comparing the conforming textual search engine queries with the updated bulk representation of textual search engine queries to detect added textual search engine queries that are in the updated bulk representation but not in the conforming textual search engine queries.

Additional blocks may also involve: (i) after the transmitting, receiving, from the third-party computing device, one or more updated files containing, in combination an updated bulk representation of textual search engine queries; (ii) in response to receiving the updated bulk representation of textual search engine queries, processing each textual search engine query, with the processing including detecting removed textual search engine queries and generating for the added textual search engine queries respective online advertising information; and (iii) transmitting, to the server device, instructions for discontinuing paid search advertising in accordance with the respective online advertising information for the removed textual search engine queries. The removed textual search engine queries may be detected by comparing the conforming textual search engine queries with the updated bulk representation of textual search engine queries to detect removed textual search engine queries that are in the conforming textual search engine queries but not in the updated bulk representation.

Additional blocks may also involve transmitting, to the third-party computing device, a representation of the non-conforming textual search engine queries and the duplicate textual search engine queries.

The embodiments of FIG. 9 may be simplified by the removal of any one or more of the features shown therein. Further, these embodiments may be combined with features, aspects, and/or implementations of any of the previous figures or otherwise described herein.

### V. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrently or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a web site configured to provide a web page by way of which users of the web site can enter textual search queries;
a computing device configured to:
(a) receive a plurality of the textual search queries that were entered into the web site,
(b) generate a set of conforming textual search queries by removing, from the textual search queries, (i) one or more of the textual search queries that contain non-alphanumeric characters, (ii) one or more of the textual search queries that contain more than a threshold number of characters, and (iii) one or more of the textual search queries that are duplicates of another of the textual search queries,
(c) apply pre-defined transformation rules to the conforming textual search queries to create records respectively associated with the conforming textual search queries, wherein a particular record in the records contains a particular conforming textual search query, a reference to the web page, and text describing a category of the particular conforming textual search query, and
(d) transmit one or more files containing the records; and
an Internet search engine configured to: receive the one or more files and a subsequent command; and display, in response to receiving a new search query that matches the particular conforming textual search query, the text describing the category of the particular conforming textual search query with an embedded link to the web site.

2. The system of claim 1, wherein the category of the particular conforming textual search query is based on a group name and a campaign name from a pre-defined hierarchy of group names and campaign names, and wherein the group name is a sub-category of the campaign name in the pre-defined hierarchy.

3. The system of claim 2, wherein the computing device is further configured to:
receive a template for creation of the records, the template defining how to generate the campaign name and the group name, wherein creating the records comprises determining the category of the particular conforming textual search query based on the template as applied to the particular conforming textual search query.

4. The system of claim 1, wherein the new search query matching the particular conforming textual search query comprises the match being an exact match or a broad match, and wherein the broad match includes misspellings, variations, and synonyms of words in the particular conforming textual search query.

5. The system of claim 1, wherein the computing device is further configured to:
place each of the textual search queries that were removed into a rejects file; and
transmit the rejects file to an entity associated with the web site.

6. The system of claim 1, wherein the computing device is further configured to:
receive a plurality of updated textual search queries that were entered into the web site by users of the web site;
generate a set of updated conforming textual search queries by removing, from the updated textual search queries, (i) one or more of the updated textual search queries that contain non-alphanumeric characters, (ii) one or more of the updated textual search queries that contain more than the threshold number of characters, and (iii) one or more of the updated textual search queries that are duplicates of another of the updated textual search queries;
apply the pre-defined transformation rules to the updated conforming textual search queries to create updated records respectively associated with the updated conforming textual search queries; and
transmit, to the Internet search engine, one or more updated files containing the updated records.

7. The system of claim 6, wherein the particular record is also in the updated records, and wherein reception of the one or more updated files containing the updated records and the particular record being in the updated records causes the Internet search engine to continue displaying the text describing the category of the particular conforming textual search query with the embedded link to the web site.

8. The system of claim 6, wherein the particular record is not in the updated records and wherein reception of the one or more updated files containing the updated records and the particular record not being in the updated records causes the Internet search engine to stop displaying the text describing the category of the particular conforming textual search query with the embedded link to the web site.

9. The system of claim 6, wherein the receiving of the plurality of the updated textual search queries, the generating of the set of the updated conforming textual search queries, the applying of the pre-defined transformation rules to the updated conforming textual search queries, and the transmitting of the one or more updated files containing the updated records occurs at least once per day.

10. The system of claim 6, wherein the records and the updated records each contain at least one million entries.

11. The system of claim 1, further comprising:
a second Internet search engine configured to: receive the one or more files and a further subsequent command; and display, in response to receiving a further new search query that matches the particular conforming textual search query, the text describing the category of the particular conforming textual search query with the embedded link to the web site.

12. A method comprising:
receiving, by a computing device, a plurality of textual search queries that were entered into a web page of a web site by users of the web site;
generating, by the computing device, a set of conforming textual search queries by removing, from the textual search queries, (i) one or more of the textual search queries that contain non-alphanumeric characters, (ii) one or more of the textual search queries that contain more than a threshold number of characters, and (iii) one or more of the textual search queries that are duplicates of another of the textual search queries;
applying, by the computing device, pre-defined transformation rules to the conforming textual search queries to create records respectively associated with the conforming textual search queries, wherein a particular record in the records contains a particular conforming textual search query, a reference to the web page, and text describing a category of the particular conforming textual search query; and
transmitting, by the computing device and to an Internet search engine, one or more files containing the records, wherein reception of the one or more files and a subsequent command by the Internet search engine causes the Internet search engine to: display, in response to receiving a new search query that matches the particular conforming textual search query, the text describing the category of the particular conforming textual search query with an embedded link to the web site.

13. The method of claim 12, wherein the category of the particular conforming textual search query is based on a group name and a campaign name from a pre-defined hierarchy of group names and campaign names, and wherein the group name is a sub-category of the campaign name in the pre-defined hierarchy.

14. The method of claim 12, wherein the new search query matching the particular conforming textual search query comprises the match being an exact match or a broad match, and wherein the broad match includes misspellings, variations, and synonyms of words in the particular conforming textual search query.

15. The method of claim 12, further comprising:
placing, by the computing device, each of the textual search queries that were removed into a rejects file; and
transmitting, by the computing device, the rejects file to an entity associated with the web site.

16. The method of claim 12, further comprising:
receiving, by the computing device, a plurality of updated textual search queries that were entered into the web site by users of the web site;
generating, by the computing device, a set of updated conforming textual search queries by removing, from the updated textual search queries, (i) one or more of the updated textual search queries that contain non-alphanumeric characters, (ii) one or more of the updated textual search queries that contain more than the threshold number of characters, and (iii) one or more of the updated textual search queries that are duplicates of another of the updated textual search queries;
applying, by the computing device, the pre-defined transformation rules to the updated conforming textual search queries to create updated records respectively associated with the updated conforming textual search queries; and
transmitting, by the computing device and to the Internet search engine, one or more updated files containing the updated records.

17. The method of claim 16, wherein the receiving of the plurality of the updated textual search queries, the generating of the set of the updated conforming textual search queries, the applying of the pre-defined transformation rules to the updated conforming textual search queries, and the transmitting of the one or more updated files containing the updated records occurs at least once per day.

18. The method of claim 16, wherein the records and the updated records each contain at least one million entries.

19. The method of claim 12, further comprising:
transmitting, by the computing device and to a second Internet search engine, the one or more files containing the records, wherein reception of the one or more files and a further subsequent command by the second Internet search engine causes the second Internet search engine to: display, in response to receiving a further new search query that matches the particular conforming textual search query, the text describing the category of the particular conforming textual search query with a further embedded link to the web site.

20. An article of manufacture including a non-transitory computer-readable medium, having stored thereon program instructions that, upon execution by a computing device, cause the computing device to perform operations comprising:
receiving, by a computing device, a plurality of textual search queries that were entered into a web page of a web site by users of the web site;
generating, by the computing device, a set of conforming textual search queries by removing, from the textual search queries, (i) one or more of the textual search queries that contain non-alphanumeric characters, (ii) one or more of the textual search queries that contain more than a threshold number of characters, and (iii) one or more of the textual search queries that are duplicates of another of the textual search queries;
applying, by the computing device, pre-defined transformation rules to the conforming textual search queries to create records respectively associated with the conforming textual search queries, wherein a particular record in the records contains a particular conforming textual search query, a reference to the web page, and text describing a category of the particular conforming textual search query; and
transmitting, by the computing device and to an Internet search engine, one or more files containing the records, wherein reception of the one or more files and a subsequent command by the Internet search engine causes the Internet search engine to: display, in response to receiving a new search query that matches the particular conforming textual search query, the text describing the category of the particular conforming textual search query with an embedded link to the web site.
